(19) United States
(12) Patent Application Publication
(10) Pub. No.: US 2016/0070868 A1
(43) Pub. Date: Mar. 10, 2016

(54) SYSTEM AND METHOD FOR COLLABORATIVE CROSS-PROVIDER REVERSE BIDDING ON A COMPONENT OF A CONSUMER MEDICAL SERVICE

(71) Applicant: Go Doctor Bid, Inc., Daytona Beach, FL (US)

(72) Inventors: Neal Hengar, Ormond Beach, FL (US); Chris Korson, Ormond Beach, FL (US)

(21) Appl. No.: 14/853,204

(22) Filed: Sep. 14, 2015

Related U.S. Application Data
(63) Continuation of application No. 14/292,826, filed on May 31, 2014, now abandoned.

(51) Int. Cl. G06F 19/00

(52) U.S. Cl. CPC G06F 19/324; G06F 19/328

(57) ABSTRACT

A method and a system of collaborative cross-provider reverse bidding on a component of a consumer medical service. A method includes determining that a user has submitted a request data related to a medical service, automatically selecting components required to fulfill a medical service, and listing the components in an online medical marketplace. The components are determined to have received compatible bids from one or more providers and may be verified to comply with geographic and/or time constraints. A symptom is associated with a diagnosis, and the set of components effecting an alternative approach to resolving the diagnosis are automatically selected. A response data is communicated to the user, and the response data may include the components with associated bids from each of the providers. In yet another embodiment, a system includes a server, a processor, a horizontal array engine, a vertical array engine, the online medical marketplace, and a network.

### FIELD OF TECHNOLOGY

This disclosure relates generally to data processing devices and, more particularly, to a system and method for collaborative cross-provider reverse bidding on a component of a consumer medical service.

### BACKGROUND

The medical services industry may be known for delays in providing patient care, high costs, and difficulty in obtaining medical insurance approval to cover a specific medical service. In addition, a set of remedial disciplines within the medical services industry may be associated with presenting a limited number of approaches to resolving a medical issue of a potential patient and may not work between and among, leaving a potential patient without a holistic treatment plan. Bidding and auctioning systems implemented in an online marketplace may generally decrease costs and increase choice associated with products and services within the general economy. However, aspects of the medical services industry may hinder realization of these advantages in the context of medical goods and services.

A bidding system for a medical service, for example, may list a pre-formulated service to be effected by a provider, the provider being, for example, a medical group, a physician's office, a physical therapy practice, a surgeon, a pediatrician, or an acupuncturist. However, the pre-formulated service may not meet the specific needs of a potential patient: it may be unnecessary for a potential patient to receive an aspect of a service package, or the service package may be missing a critical component. As a result, the price associated with the service package may be too high or one or more of the procedures inappropriate.

A “reverse bidding” system, in which a provider bids on a medical service selected by a potential patient, may allow some ability for the potential patient to formulate the medical service to be bid upon by the provider. However, the potential patient may still not be able to compare the relative cost of individual aspects of the services. Specifically, the potential patient may not have enough information to formulate the appropriate medical service.

One aspect of being unable to formulate the appropriate medical service may be a lack of awareness of alternative approaches. Bidding systems may ignore non-conventional medical services. For example, a growing body of research, including peer-reviewed research, may show that alternative remedial disciplines such as Eastern medicine and Ayurvedic medicine may be effective for some potential patients. The potential patient may be unable to appreciate costs and benefits associated with alternative approaches across a set of remedial disciplines. For example, the potential patient may not be able to weigh the lowest competitive price for a surgery when compared to the lowest price for an acupuncture regimen offered by several different acupuncturists.

Once a medical service is formulated, a set of providers may have differing opinions and/or beliefs about what aspects (such as a treatment, a procedure, and/or a medication) are required to complete the medical service. Further, while each of the set of providers may bid on a medical service, the set of providers may be bidding on a pre-formulated package, and therefore the provider most suited to service many aspects of the pre-formulated package may choose not to bid if the provider believes they are not equipped to handle one of the aspects of the pre-formulated package (e.g., a surgical procedure, a recovery care outside the scope of the provider, a facility for performing a treatment). Providers that may otherwise work effectively and/or synergistically on multiple aspects of the medical service may be foreclosed from jointly providing medical services and may therefore lose revenue opportunities. Similarly, alternative approaches to medicine may not be considered by the potential patient, preventing alternative treatment and/or an interdisciplinary approach that may leave a patient with an ineffective, uninformed, and costly medical service.

### SUMMARY

Disclosed are a method, a device and/or a system of collaborative cross-provider reverse bidding on a component of a consumer medical service.

In one embodiment a method includes determining that a user has submitted a request data related to a medical service. The method applies a geographic constraint of the medical service when the user selects a geographic preference and then applies a time constraint of the medical service when the user selects a time preference. The method also automatically selects a set of components required to fulfill the medical service using a database, and lists each of the set of components required to fulfill the medical service in an online medical marketplace.

It is determined that each of the set of components have received a bid from a provider that is compatible with each one of other providers submitting bids related to the set of components based on an availability of each of the providers submitting bids related to the set of components. Each of the set of providers submitting bids related to the set of components are verified to comply with the geographic constraint and/or the time constraint when the user selects the geographic constraint and/or the time constraint. A response data is communicated to the user and the response data includes associated bids from each of the providers submitting bids related to the set of components. The set of components have been verified to comply with the geographic constraint and/or the time constraint when the user selects the geographic constraint and/or the time constraint.

The request data may include a symptom, a procedure, a remedy, a treatment, a medication, a pharmaceutical, a diagnosis, a therapy, a consultation, a medical specialty, and/or an analytical test. Each of the set of components required to fulfill the medical service may be a facility, the procedure and/or a different procedure, the remedy and/or a different remedy, the treatment and/or a different treatment, the medication and/or a different medication, the pharmaceutical and/or a different pharmaceutical, the therapy and/or a different therapy, the consultation, an ambulation service, and/or the analytical test and/or a different analytical test. The symptom, the procedure, the remedy, the treatment, the medication, and/or the pharmaceutical may be associated with the diagnosis based on the database and the diagnosis of the database may be associated with an alternative approach to resolving the diagnosis. The alternative approach to resolve the diagnosis may be an herb, an Eastern medicine, an Ayurveda medicine, a non-traditional Western medicine, an experimental medicine, a counseling, a seminar, a lifestyle, a nutritional approach, and/or a spiritual guidance. The set of components required to fulfill the medical service may be the set of components required to effect the alternative approach to resolving the diagnosis. The user may be presented with a peer-reviewed research on the alternative approach.

A personally identifiable information associated with the user requesting the medical service may be masked when listing each of the set of components required to fulfill the medical service in the online medical marketplace. The response data may include an identification and/or an insurance network of each of the set of providers submitting bids to the set of components associated with the medical service. A sequence may be determined to be mandated in which each of the set of components required to fulfill the medical service must be performed in a specified order, and each of the set of providers submitting bids related to the set of components may be determined to adhere to the sequence when the sequence is mandated. An information required to assess a transactional cost associated with servicing each of the set of components may be identified, and the information required to assess the transactional cost may be a weight, a genetic predisposition, a health history, a substance abuse, and an associated symptom. The information required to assess the transactional cost may also be a previous procedure, a current prescription, a current health condition, and/or a current herbal intake. The information of the user may then be collected. The method may allow an additional component is added to the set of components by the set of providers submitting bids and/or the response data may include an associated bid on the additional component.

In addition, the method may process an acceptance by the user of a bid by a single provider of the set of providers on multiple units of a single component of the set of components. In such case, the user may be an administrator of an organization bargaining on behalf of an employee of the organization and/or a contractor of the organization. An electronic contract obligating the single provider to service the multiple units of the single component at a price of the bid by the single provider may be processed. Further, the single component may be presented to an employee of the organization and/or a contractor of the organization. The method may further include processing a designation of a preferred provider of the set of providers. The designation may be made by the user, and the preferred provider may be presented with the request data.

In another embodiment, a method, which employs a computer processor and physical memory, includes associating a symptom, a procedure, a remedy, a treatment, a medication, and/or a pharmaceutical with a diagnosis, the association based on a database. The diagnosis is an alternative approach to resolving the diagnosis. It is determined that a user has submitted a request data related to a medical service, and a set of components is automatically selected to fulfill the medical service using a database. The set of components required to fulfill the medical service is the set of components required to effect the alternative approach to resolving the diagnosis.

The method lists each of the set of components required to fulfill the medical service in an online medical marketplace. Each of the set of components us determined to have received a bid from a provider that is compatible with each one of other providers submitting bids related to the set of components based on an availability of each of the providers submitting bids related to the set of components. A response data is then communicated to the user. The response data includes associated bids from each of the providers submitting bids related to the set of components.

In yet another embodiment, a system includes a server, having a physical memory and a computer processor. The processor of the server is configured to associate a symptom, a procedure, a remedy, a treatment, a medication, and/or a pharmaceutical with a diagnosis based on a database. The processor automatically selects a set of components required to fulfill a medical service using the database, and lists each of the set of components required to fulfill the medical service in an online medical marketplace. The processor also determines that each of the set of components has received a bid from a provider that is compatible with each one of other providers submitting bids related to the set of components based on an availability of each of the providers submitting bids related to the set of components.

The system also includes a horizontal array engine that associates the diagnosis with an alternative approach to resolving the diagnosis, and a vertical array engine, to determine that the user has submitted a request data related to the medical service. Finally, the system includes the online medical marketplace and a network.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a medical service component reverse bidding network that shows one or more users communicating a request data related to a medical service through a network to a server, the server determining a set of components required to fulfill the medical service and listing the set of components in an online medical marketplace to be bid upon by a set of providers, according to one or more embodiments.

FIG. 2 is a reverse bidding server view showing the server of FIG. 1, the server including a computer processor, a memory, and a database, the server also including the horizontal array engine that may parse the medical request data of the user across a set of remedial disciplines and the vertical array engine that may determine a set of medical services within each remedial discipline and a set of components required to fulfill each medical service, the user choosing which remedial discipline of the horizontal array and which medical service of the vertical array for which the user would like to receive bids from the set of medical providers, according to one or more embodiments.

FIG. 3 is a horizontal and vertical array view showing a depiction of a set of medical services that may be used to treat Bell's palsy, a form of facial nerve paralysis, including alternative approaches to resolving Bell's palsy across a set of remedial disciplines such as Eastern medicine, Ayurvedic medicine, experimental medicine, and spiritual healing, according to one or more embodiments.

FIG. 4 is a process flow showing the method by which a request data of the user may, through a number of operations, be used to produce a response data, the response data comprising a set of associated bids on each of the set of components fulfilling the medical service of FIG. 3, according to one or more embodiments.

FIG. 5 is a process flow showing the method by which the set of components required to fulfill the medical service of FIG. 4 may require an information to allow a provider to assess a transactional cost associated with servicing each of the set of components, the information collected and a personally identifiable information associated with the user masked when listing each of the components in the online marketplace, according to one or more embodiments.

FIG. 6 is a compatible provider reverse bidding view showing a consumer (who may be the user) formulating a medical service comprising a set of components and submitting the medical service to the online medical marketplace of FIG. 1 to be bid upon by the set of providers to result in a response data of a set of providers compatible to service the set of components in order to complete the medical service, according to one or more embodiments.

FIG. 7 is an individual component bidding view that shows one or more associated bids on each of the set of components, the response data presenting each bid of each provider on each component such that the consumer may choose the best bid for each component, according to one or more embodiments.

FIG. 8 is an organizational leveraged bargaining view showing an organization administrator of an organization submitting a medical service comprising a block of multiple units of a first component and a second component to be bid upon by the set of providers, the organization administrator selecting the appropriate bids within the response data to form an electronic contract obligating the set of providers selected by the organization administrator to provide a medical service associated with the first component and the second component to an employee (e.g., a full-time employee, a part-time employee, a contractor) of the organization, according to one or more embodiments.

FIG. 9 is a process flow showing the method by which the request data may be associated with a diagnosis which may in tern be associated, using a database, with an alternative approach to resolving the diagnosis and automatically selecting a medical service required to effect the alternative approach along with the set of medical components require to fulfill the medical service, according to one or more embodiments.

### DETAILED DESCRIPTION

Disclosed are a method, a device and a system of collaborative cross-provider reverse bidding on a component of a consumer medical service. Although the present embodiments have been described with reference to specific example embodiments, it will be evident that various modifications and changes may be made to these embodiments without departing from the broader spirit and scope of the various embodiments.

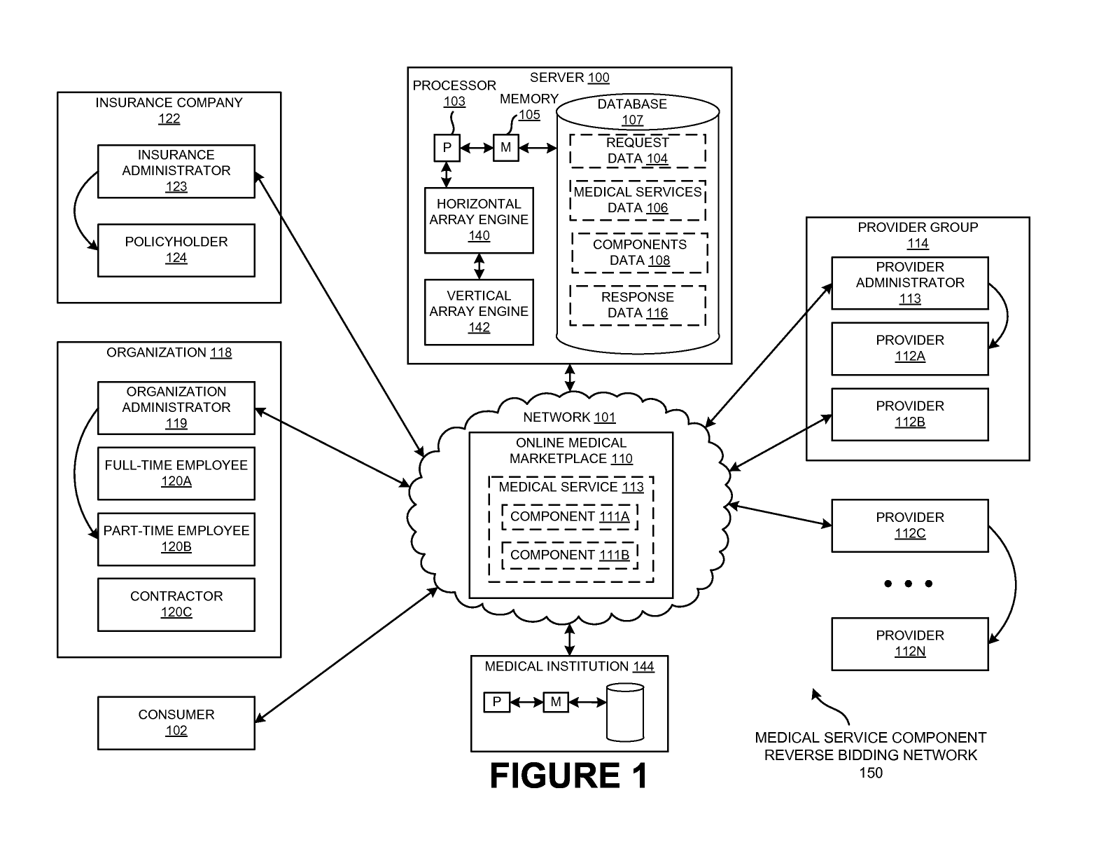

FIG. 1 is a medical service component reverse bidding network 150 that shows one or more users communicating a request data related to a medical service through a network to a server, the server determining a set of components required to fulfill the medical service and listing the set of components in an online medical marketplace to be bid upon by a set of providers, according to one or more embodiments. Particularly, FIG. 1 illustrates a server 100, a network 101, a consumer 102, a processor 103, a request data 104, a memory 105, a medical services data 106, a database 107, a components data 108, an online medical marketplace 110, a set of components 111 including a component 111A and a component 111B, a set of providers 112 (provider 112A through 112N), a provider administrator 113, a provider group 114, a response data 116, a set of agents of an organization 118 including an organization administrator 119, a full-time employee 120A, a part-time employee 120B, and a contractor 120C, an insurance company 122, an insurance administrator 123, a policy holder 124, a horizontal array engine 140, a vertical array engine 142, and a medical institution 144.

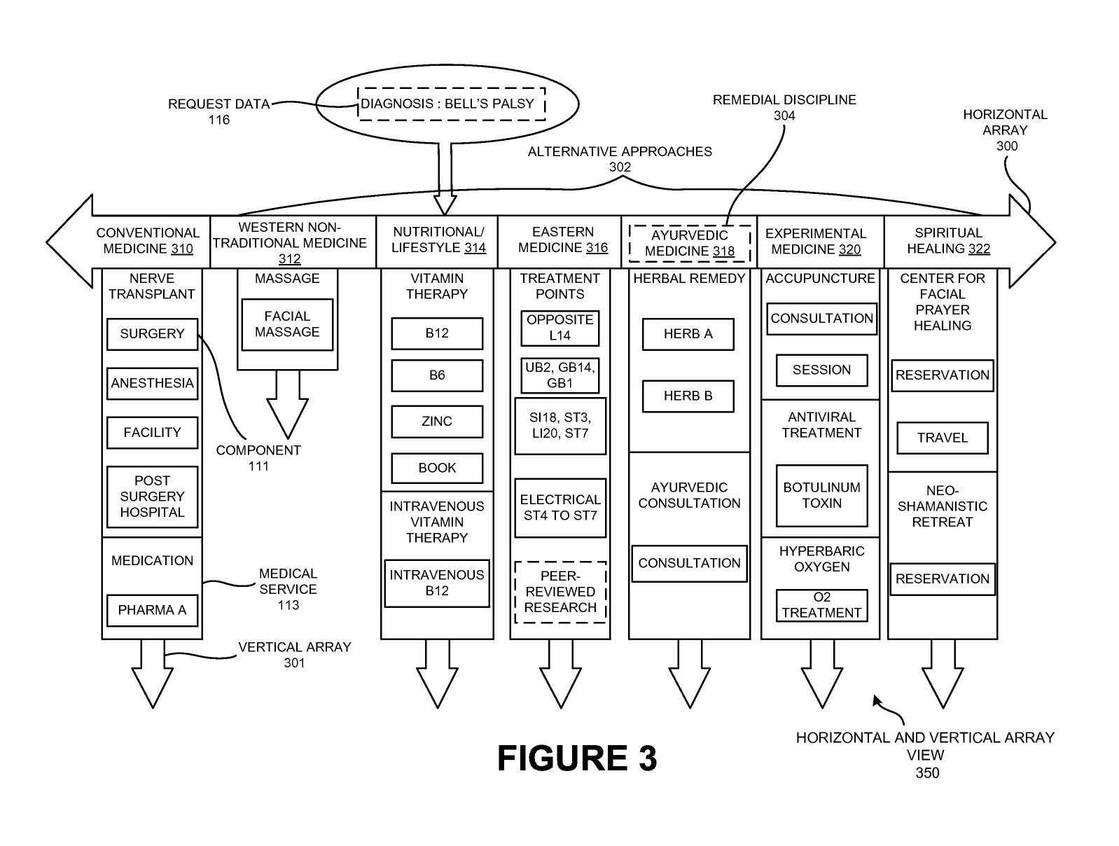

In FIG. 1, a user may submit the request data 104 through the network 101 to the server 100. The network 101 may be a wide area network, such as the Internet. A “user” may refer to the consumer 102, the organization 118, the organization administrator 119, the full-time employee 120A, the part-time employee 120B, the contractor 120C, the insurance company 122, the insurance administrator 123, and the policy holder 124. The request data 104 may, for example, be a symptom (such as a headache, partial blindness, general fatigue), a procedure (such as a hip replacement, teeth whitening), a remedy (such as a method of freezing off a wart), a treatment, a medication, a pharmaceutical (such as a cholesterol medication, epinephrine, medical marijuana), a diagnosis (such as schizophrenia, hepatitis C, Bell's Palsy), a therapy (such as immunotherapy, chemotherapy), a consultation (such as a general physical examination, an eye exam), a medical specialty (such as dermatology), and an analytical test (such as general blood work, a test for Lyme disease, a sexually transmitted disease screening). Upon submission of the request data 104 to the server 100, the server 100 may compare the request data 104 to a set of medical services that may match the request data 104. First, the request data 104 may be parsed by the horizontal array engine 140 to determine a set of remedial disciplines (e.g., the remedial discipline 304 of FIG. 3) that may include medical services 115 potentially resolving the request data 104. For example, the horizontal array engine 140 may reference a lookup-table within the database 107 (and/or a non-relational database equivalent) to determine that the symptom “malaise” has an associated medical service to resolve the malaise in conventional Western medicine, Eastern medicine, and Ayurvedic medicine. Additionally, a new treatment considered to be experimental medicine may be available for chronic fatigue, for example a new pharmaceutical.

Next, the vertical array engine 142 may define the set of medical services 115 corresponding to each remedial discipline determined to have a medical service resolving the request data 104. For example, when the request data 104 is a specific procedure, such as a “knee surgery,” a set of the medical services 115 within the remedial discipline of conventional medicine may be several instances of the knee surgery such as an ACL reconstruction, an Arthroscopy, and a knee-replacement surgery. Optionally, the server 100 may ask the user to specify which type of knee-surgery the user may desire before determining the medical service 115. Where the request data 104 is a specific symptom, such as “Hymenoptera anaphylaxis,” the medical services 115 matching the request data 104 may be epinephrine (which may be a medication and/or pharmaceutical) and venom immunotherapy (which may be a treatment).

The server 100 may then reference the database 107 to match the medical service 115 to a set of components 111 (e.g., the component 111A, the component 111B) within the components data 108 that fulfill the medical service 115. The user may then view a set of the medical services 115, as formulated by the server 100, the set of medical services 115 possibly being drawn from several remedial disciplines. In one embodiment the user may add and/or subtract one or more of the components 111 from the one or more components 111 comprising the medical service 115. For example, the medical service 115 may be comprised of the component 111A which may be a hip replacement surgery and component 111B may be anesthesia required for the hip replacement surgery represented by the component 111A.

Upon specifying the set of components 111 that the user would like to submit such that a bid may be placed on each component 111, the server 100 may determine that an information may be required for a provider 112 to assess a transactional cost associated with servicing a particular component 111 of the medical service 115. For example, a surgeon may generally need to know the weight of a potential patient and whether the patient is on a blood-thinning medication such as Warfarin. The set of components 111 selected by the user may therefore determine the content of an information request from the server 100 to the user. Alternately, the server may scrape and/or import data through an API from the medical institution 144, which may be a medical data repository, a third-party medical information database, and/or a patient management system. The medical institution 144 may also be an instance of the provider 112 and/or the provider group 114.

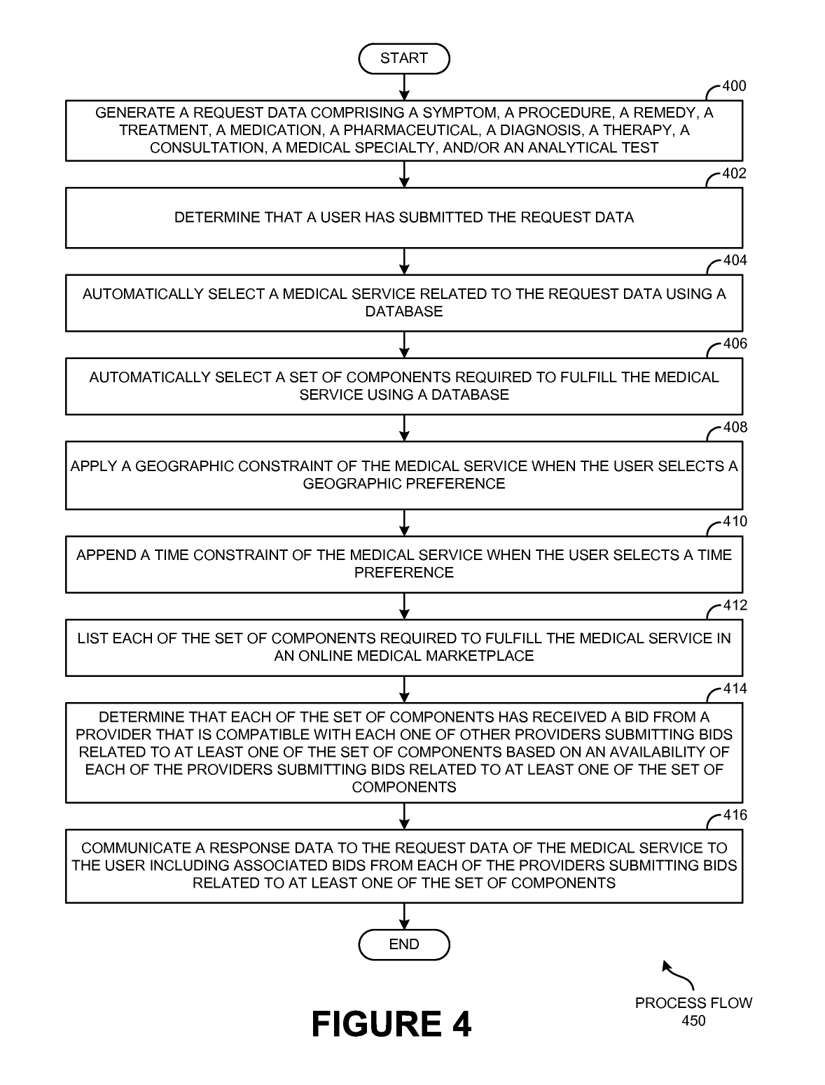

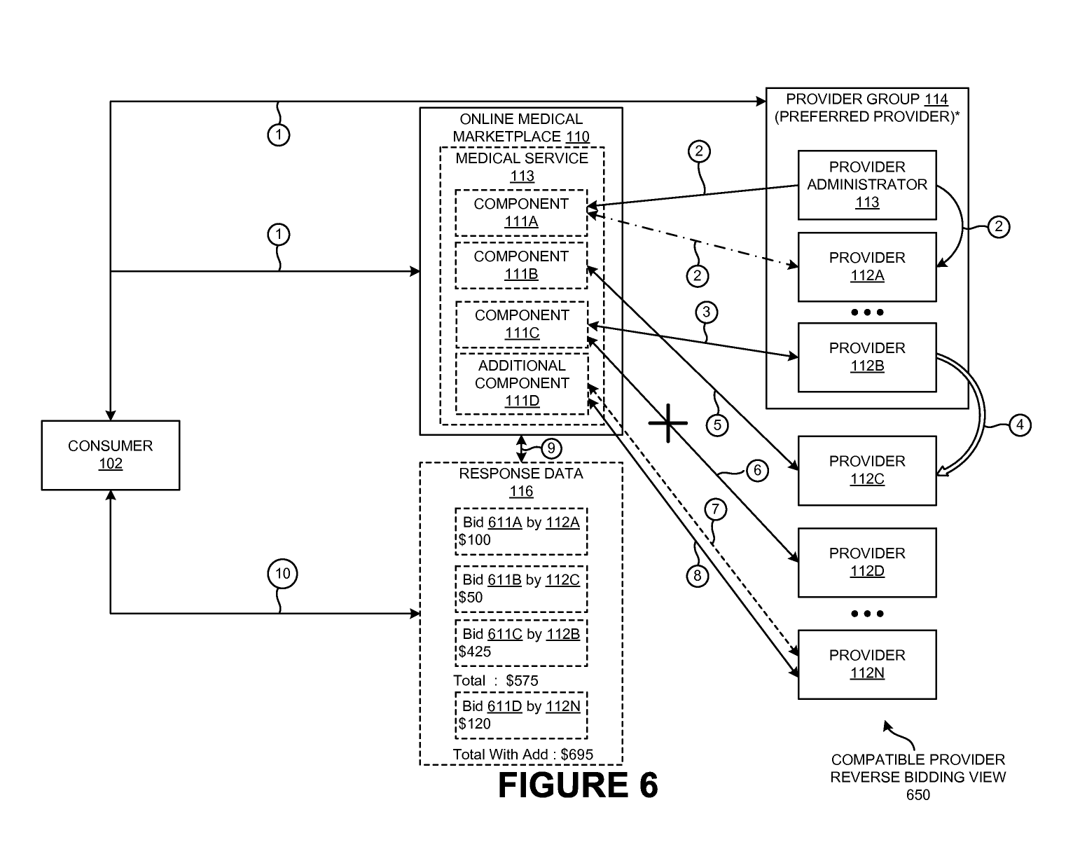

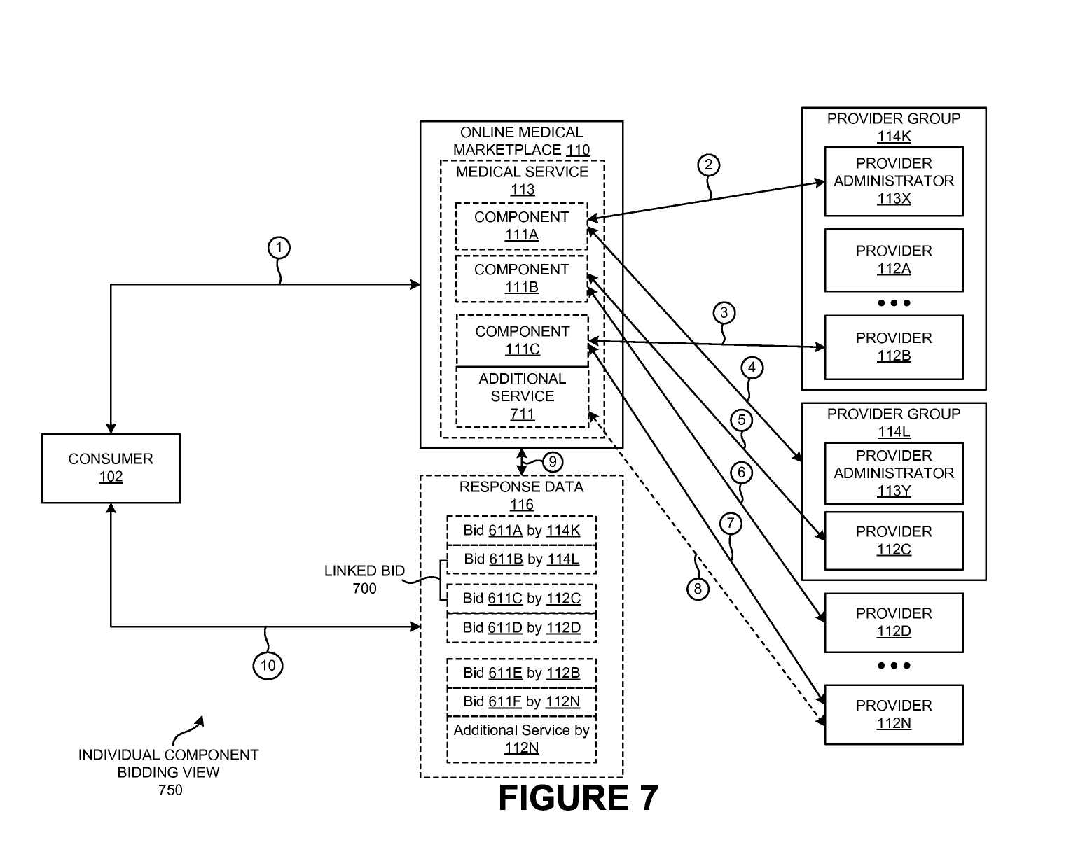

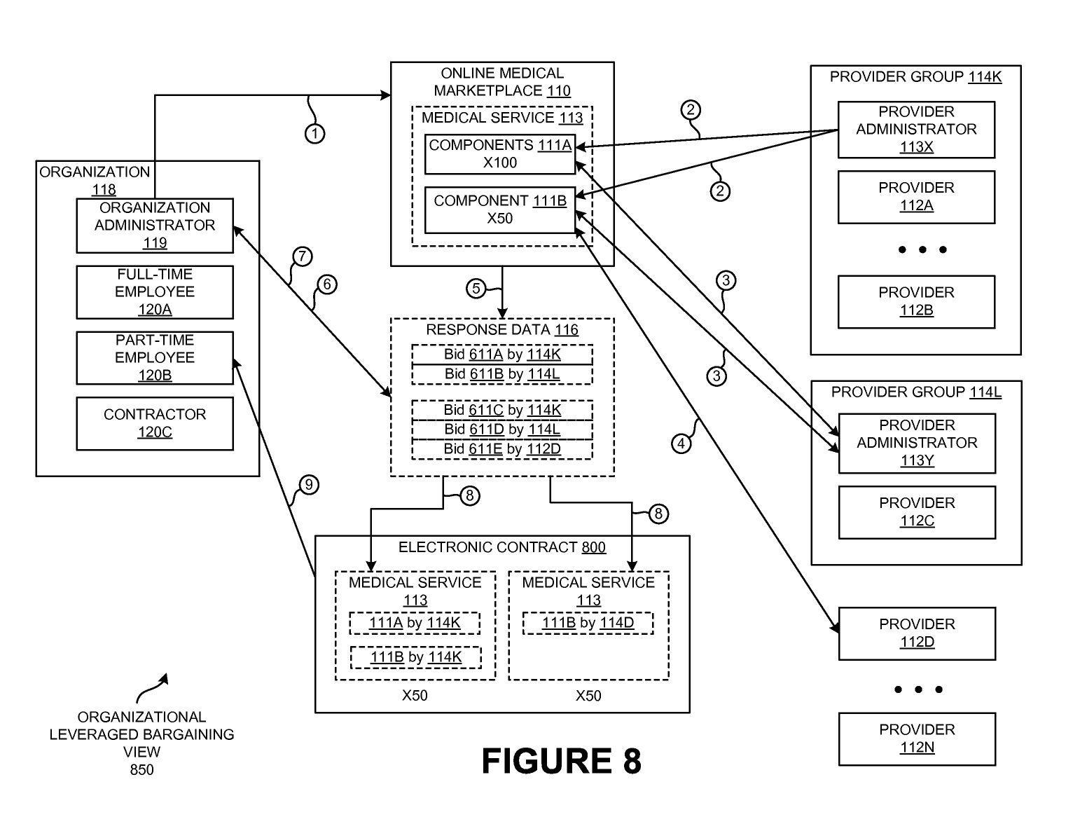

Upon approval by the user and processing of time and/or geographic constraints that the user may submit, the components 111 may be listed on the online medical marketplace 110. The online medical marketplace 110 may be a website (e.g., an e-commerce website) on the Internet, and may be hosted in the same location as the server 100, at a different server, or through a distributed database architecture. The set of providers, e.g., the provider 112A through 112N, may then bid on each of the components 111 comprising the medical service 115, as shown and described in conjunction with FIG. 6, FIG. 7, and FIG. 8. The server 100 may determine that each of the components 111 have an associated bid from at least one of the providers 112, and may determine that the bids placed by the set of providers 112 are compatible with each other, as discussed in conjunction with FIG. 4.

Upon determining that each of the components 111 have the associated bid from at least one instance of the provider 112 and that the bids from all providers 112 are compatible, the server 100 may formulate the response data 116 comprising the components 111 with associated bids from the providers 112 and transmit the response data 116 to the user. The user may then decide whether to accept or reject the bids of one or more components 111.

The request data 104 may also be comprised of a set of non-conventional instances of the procedure, the treatment, the medication, the diagnoses, the therapy, the consultation and/or the analytical test. For example, the request data 104 may be comprised of a medication that is an herbal medication (e.g., mint extract, eucalyptus oil, camphor) or a treatment that is a spiritual treatment (e.g., a shamanistic ceremony for removing depression, a Christian healing center specializing in spinal chord injuries). In such case, the horizontal array engine 140 may work to present a conventional treatment to the user (e.g., the consumer 102) when the user is most comfortable with, and originally searching for a provider of, a non-conventional treatment such as a folk remedy.

An experimental medicine may be a treatment, a remedy, a medicine, a pharmaceutical, and/or a procedure not covered by most insurance companies. An experimental medicine may also be a treatment, a remedy, a medicine, a pharmaceutical, and/or a procedure that has not received government approval in the United States (e.g., from the FDA), even where approval has been given in countries outside the United States by agencies of those countries. An experimental medicine may also be understood to a treatment, a remedy, a medicine, a pharmaceutical, and/or a procedure that precedes and informs the development of a late phase clinical trial. The experimental medicine (e.g., the experimental medicine 320 of FIG. 3) may be based on an investigation undertaken in humans, relating where appropriate to model systems, to identify mechanisms of pathophysiology or disease, or to demonstrate proof-of-concept evidence of the validity and importance of new discoveries and/or treatments. In another example, the experimental medicine may be a treatment, a remedy, a medicine, a pharmaceutical, and/or a procedure that is undergoing clinical trials used to determine efficacy and/or safety for human use.

The provider 112 may be an individual that provides medical services. The provider 112 may be associated with a number of remedial disciplines. The provider 112 may be, in the remedial discipline of conventional medicine (e.g., the conventional medicine 310 of FIG. 3), a licensed physician, a psychiatrist, a nurse practitioner, or a surgeon. The provider 112 may also be a small number of individuals that may choose to bid together. For example, the provider 112 may be a small office having one oral surgeon and one anesthesiologist. The provider group 114 may be an entity that provides medical services. For example, within the context of the conventional medicine, the provider group 114 may be a medical group, an HMO network, a hospital, a specific facility, and/or a research center. The provider administrator 113, which may be an optional individual or department within the provider group 114, may be able to manage bidding for the set of providers 112 within the provider group 114. In FIG. 1, the provider administrator 113 may be a managerial personnel of the provider group 114 that views a listing of the online medical marketplace 110 and may bid on behalf of the provider 112A who may be part of the provider group 114.

However, the provider 112 may also be defined within each of a set of alternative approaches other than conventional medicine. For example, the provider 112 within a western non-traditional medicine (e.g., the western non-traditional medicine 312 of FIG. 3) may be a message therapist. Within the remedial discipline of nutritional and/or lifestyle guidance (e.g., the nutritional/lifestyle guidance 314 of FIG. 3), the provider 112 may be a nutritional expert or a lifestyle counselor. Within the remedial discipline of Eastern medicine (e.g., the Eastern medicine 316 of FIG. 3), the provider 112 may be an acupuncturist and/or an herb shop. Within the remedial discipline of spiritual healing (e.g., the spiritual healing 322 of FIG. 3), the provider 112 may be a religious organization, a center known for a specific type of healing (e.g., spinal chord restoration through prayer), and/or a shaman (e.g., a medicine man, a “witch-doctor”) of one or more ethnic and/or religious associations.

When the user is the policy holder 124, upon accepting one or more of the bids on the components 111, the user may pay for the medical services in cash, schedule with each individual instance of the providers 112, and later submit reimbursement for the medical services 115 and/or the components 111 from the insurance company 122. In the alternative, as described in conjunction with FIG. 8, the insurance company 122 may be the user that may leverage bargaining power in order to receive bids by the set of providers 112 on a block of the medical services 115 that the insurance company 122 may then offer on an individual basis to their policy holders 124.

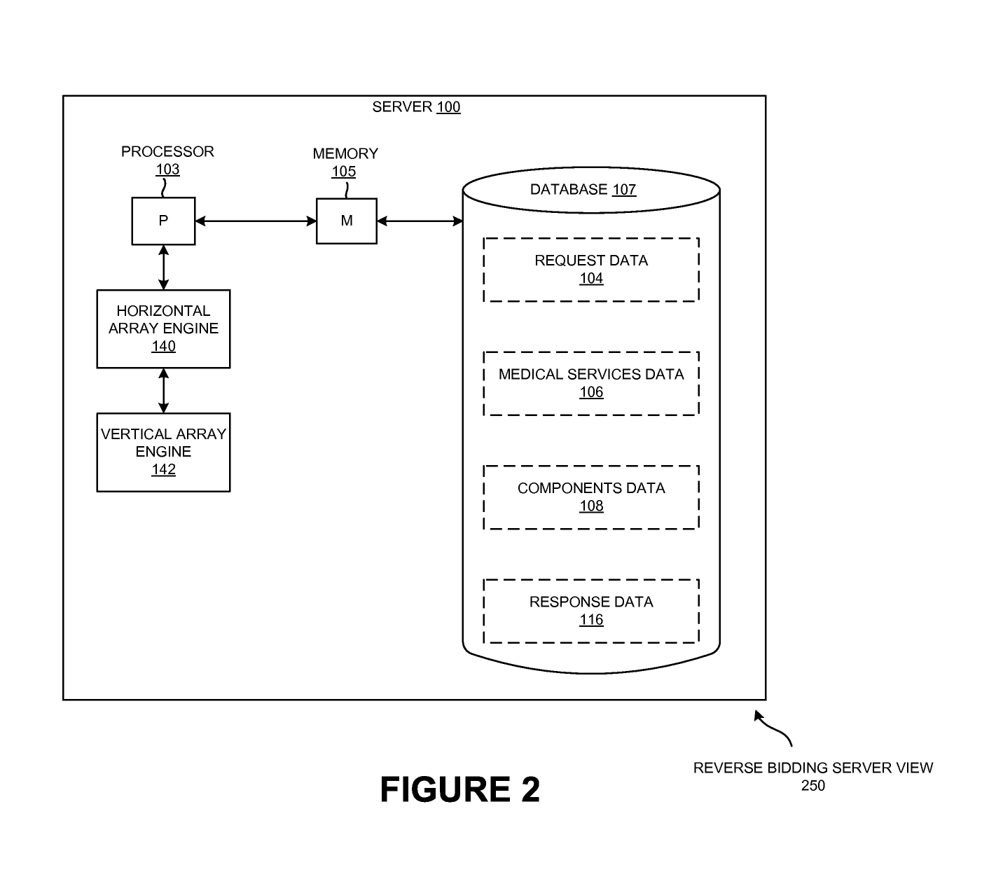

FIG. 2 is a reverse bidding server view showing the server of FIG. 1, the server including a computer processor, a memory, and a database, the server also including the horizontal array engine that may parse the medical request data of the user across a set of remedial disciplines and the vertical array engine that may determine a set of medical services within each remedial discipline and a set of components required to fulfill each medical service, the user choosing which remedial discipline of the horizontal array and which medical service of the vertical array for which the user would like to receive bids from the set of medical providers, according to one or more embodiments. In FIG. 2, the medical services data 106 may be a set of data associating potential inputs of the request data 104 with appropriate instances of the medical services 115 that may resolve the request data 104. For example, the medical services data may be a look-up-table that associates a nerve transplant as one instance of the medical service 115 that may resolve the diagnosis of Bell's palsy. The components data 108 may be the set of components 111 associated with each of the medical services 115 within the medical services data 106. For example, the components data 108 may associate the set of components 111 required to effect nerve transplant, and those components may be a surgery, an anesthesia, and a facility at which the surgery and the anesthesia are conducted. The response data 116 may be the set of components 111, corresponding to a particular instance of the medical service 115 that have associated bids by the set of providers of FIG. 1.

The same instance of the medical service 115 may occur in multiple instances of the remedial discipline 304. For example, some medical services 115 within the vertical array 301 corresponding to the Eastern medicine 316 may also be appropriate to include within the vertical array 301 corresponding to the spiritual healing 322. For example, a Buddhist meditation retreat in response to a request data 104 including a symptom of a stress may be included under the eastern medicine 316, the nutritional/lifestyle guidance 314, and/or the spiritual healing 322.

FIG. 3 is a horizontal and vertical array view 350 showing a depiction of a set of medical services that may be used to treat Bell's palsy, a form of facial nerve paralysis, including alternative approaches to resolving Bell's palsy across a set of remedial disciplines such as Eastern medicine, Ayurvedic medicine, experimental medicine, and spiritual healing, according to one or more embodiments. In particular, FIG. 3 further illustrates a horizontal array 300, a vertical array 301, a set of alternative approaches 302, and a set of remedial disciplines 304 including a conventional medicine 310, a Western non-traditional medicine 312, a nutritional/lifestyle guidance 314, an Eastern medicine 316, an Ayurvedic Medicine 318, an experimental medicine 320, and a spiritual healing 322.

In FIG. 3, the user has submitted an instance of the request data 104 that may be the diagnosis of Bell's palsy. In the alternative, the user may have submitted the request data 104 that includes one or more instances of a symptom that was determined by the server 100 to be consistent with a diagnosis of Bell's palsy, or may have submitted a procedure such as a facial nerve transplant consistent with the treatment of Bell's palsy. The horizontal array 300 may be generated by the horizontal array engine 140 of the server 100 by referencing the medical services data 106 to determine which set of remedial disciplines 304 to comprise instances of the medical service 115 that resolve Bell's palsy. The “resolution” of a diagnosis may include a wide range of responses ranging from a temporary alleviation of a symptom (and/or a cosmetic covering of the symptom) to a complete cure. In some instances, however, a procedure may not have an associated diagnosis. For example, a general cosmetic surgery (that may not be related to facial reconstruction after an accident) may not have an associated diagnosis. In such case, the horizontal array engine 140 may still determine a set of medical services 115 related to the general cosmetic surgery, including an application of botulinum toxin (e.g., Botox®), for example, or, in the context of the set of alternative approaches 302, an herbal mask that may increase appearance of youth according to one or more of the remedial disciplines 304.

The horizontal array 300 may be important to allow the user to assess the set of alternatives available to resolve a content of the request data 104 and/or the diagnosis generated as a result of analysis of the request data 104 by the server 100. In the context of FIG. 3, for example, the user may want to try the western non-traditional medicine 312 instance of the alternative approach 302 of a facial massage in combination with the nutritional/lifestyle guidance 314 of a vitamin therapy before spending the time and accepting a risk associated with the nerve transplant of the conventional medicine 310. The user may also wish to submit both the nerve transplant and the vitamin therapy to the online medical marketplace 110 to determine the relative cost of each after each of the set of providers 112 bids on the nerve transplant and the vitamin therapy. The horizontal array 300 may be presented to the user in a number of different ways, for example by presenting a graphical user interface having tabs for each of the remedial disciplines 304. The vertical array engine 142 may associate each of the set of medical services 115 with each of the set of remedial disciplines 304 to form the vertical array 301.

The Eastern Medicine 316 may also be an oriental medicine. The Eastern Medicine 316 may be a medicine traditionally known to be associated with Asia. In one or more embodiments, the Eastern Medicine 316 may be a traditional Chinese medicine (which may be also known as TCM) which may share common concepts that may have been developed in China over a period of 2,000 years, including various forms of herbal medicine, acupuncture, massage (“Tui na”), exercise (“qigong”), and dietary and/or herbal therapy. For example, the traditional Chinese medicine may be based on the Yellow Emperor's Inner Canon, also known as the “Huangdi Neijing.”

The Ayurvedic Medicine 318 may be a system of Hindu and/or Vedic traditional medicine native to the Indian subcontinent. The Ayurvedic Medicine 318 may be based on the oldest known Ayurvedic texts such as the Suśrutha Samhitā and the Charaka Samhitā, which may be among the foundational and formally compiled works of Ayurveda. The Ayurvedic Medicine 318 may be based on a basic principle to prevent and treat illness by maintaining balance in the body, mind, and consciousness through proper drinking, diet, and lifestyle, as well as herbal remedies. The Ayurvedic Medicine 318 may be based on “doshas,” a distinct pattern of energy that may form a specific combination of physical, mental, and emotional characteristics of the user.

The Western Non-Traditional Medicine 312 may refer to a medicine that is delivered in the United States but is not recognized as a conventional, orthodox, scientific, or a mainstream medicine treatment and is not covered by conventional insurance plans. In one or more embodiments, the Alternative Approaches 302 may also include a counseling. The counseling refer to any assisted development whether psychological, wellness, spiritual, pregnancy or other support involving a certified counselor and a patient (e.g., the user). A seminar may refer to a gathering of a group of persons with intentions to learn or become educated on a particular subject.

The nutritional/lifestyle guidance 314 may be referred to either a nutrition approach or a lifestyle approach for health. The lifestyle approach may refer to a routine set of habits or habitual behaviors that lead to a particular state of health. For example, the lifestyle approach may be a sleep regimen and/or hygiene, an exercise routine, a meditation routine, a yoga routine, maximum caffeine intake, a maximum nicotine intake, etc. The nutritional approach may be a health method that involves treatment of a disease, condition and/or ailment with a particular food or supplement based on phytochemical and/or Alkaloids present in the food or supplement. The nutritional approach may be a recommended allotment of nutrients over a given time period (e.g., milligrams of Vitamin C and/or polyphenol compounds), a recommended number of fruits and vegetables, a recommended kind and/or type of food, and/or a list of recipes. For example, if the content of the request data 104 included “inflammation,” the nutritional approach may include a food that studies have shown reduced inflammation (e.g., beets, ginger, almonds) and/or a recipe on how to prepare the food. The spiritual healing 322 may be a practice of deepening a perceived personal relationship with a divine entity that may include a procedure whereby one or more persons aids others to learn and experience spiritual healing. The spiritual healing 322 may be a sharing procedure in which the user, who may be seeking direction on sicknesses, diseases, pains, infirmities, injuries, mental illnesses, curses, vows, and/or medical issues, may seek the advice and/or counsel of a spiritual director (e.g., a member of a clergy, a shaman), who may :listen and ask questions to assist the user in his or her process of reflection and spiritual healing. Spiritual direction (e.g., the spiritual healing 322) may have been shown to have effects such as complete or partial healing, decreasing anxiety, and decreasing stress. The spiritual healing 322 may involve a reading, listening, declaration. blessing, a laying on of hands, a holy treatment (e.g., applying oil) and/or a prayer.

The horizontal array engine 140 and/or the vertical array engine 142 may also account for demographic data such as ethnicity, national origin, geographic region and/or religion in determining relevant instances of the remedial disciplines 304 to display to the user. For example, a user residing in San Francisco, Calif., may be more likely to pursue the alternative approaches 302 than a user residing in a rural portion of Nebraska. Weights may be given to each of a set of ethnic, national origin, geographic, and/or religious factors in determining which of the remedial disciplines 304, medical services 115, and components 111 are presented for consideration to the user. In one embodiment, however, all remedial disciplines 304, medical services 115, and components 111 that may resolve the content of the request data 104 may be presented to the user.

Consideration of the horizontal array 300 of remedial disciplines 304 may provide an effective resolution to the content of the request data 104. Specifically, the user may be exposed to a treatment that is effective even while not endorsed and/or recognized by the conventional medicine 310. In addition, a placebo effect may be especially prominent in a remedial discipline 304 that the user believes to be best suited to them. Studies may show that the placebo effect may be especially applicable to depression, pain, sleep disorder, and menopause. Therefore, even the medical services 115 within the alternative approaches 302 lacking the peer-reviewed research 324 may be effective. A user of a specific ethnic background may respond most positively to a combination of the medical services 115 within both the conventional medicine 310 and the alternative approaches 302. In a specific instance, a user of Chinese-American heritage may believe that he or she should both receive a medical service 115 that is a spiritual healing 322 to augment the conventional medicine 310. For example, the user of Chinese-American heritage may wish to have a yoga therapy along side the conventional medicine 310. In one embodiment, a provider bidding on the component 111 of a first medical service 115 may be able to observe a different medical service 115 that the user submitted to the online medical marketplace 110 in order for the provider to have a holistic and/or contextual view of the user's approach to medicine. In many clinics in ethnic communities, for example, it is important for a licensed physician to appreciate and not disparage alternative approaches (e.g., a shamanistic or spiritual healing) in order to receive credibility in the eyes of patients, such credibility making a difference, for example, in whether the patient will take a pharmaceutical drug and/or regularly return to the physician for additional treatment or observation.

Therefore, the selection of a remedial discipline 304 by the horizontal array 300, the selection of a medical service 115 and associated set of components 111 by the vertical array 301, and bidding by the set of providers 112 on the set of individual components 111 may work together synergistically to maximize choice to the user associated with the medical service 115 and/or components 111, as well as minimize cost to the user for the medical service 115 and/or the components 111. At the same time, new revenue opportunities may be generated for the set of providers bidding on the components 111, along with an inter-disciplinary awareness between and among the set of providers 112 spanning multiple instances of the remedial disciplines 304. The implementation of this efficient reverse bidding system through, for example, the medical service component reverse bidding network 150, may create a revenue opportunity for an operator of the server 100 and/or the online medical marketplace 110, such as advertising revenue, subscription fees, search fees, and/or a percentage of revenue from bids on medical services 115.

FIG. 4 is a process flow showing the method by which a request data of the user may, through a number of operations, be used to produce a response data, the response data comprising a set of associated bids on each of the set of components fulfilling the medical service of FIG. 3, according to one or more embodiments. Operation 400 may generate a request data (e.g., the request data 104) comprising a symptom, a procedure, a remedy, a treatment, a medication, a pharmaceutical, a diagnosis, a therapy, a consultation, a medical specialty, and/or an analytical test. The request data may be generated, for example, by a search bar, a drop-down menu, or a workflow that allows the user to enter one or more instances of a symptom, a procedure, a remedy, a treatment, a medication, a pharmaceutical, a diagnosis, a therapy, a consultation, a medical specialty, and/or an analytical test. In a specific example, the user may be experiencing depression and therefore may input “depression” (which may be a symptom), “sadness” (which may be a symptom), apathy (which may be a symptom), psychiatry (which may be a specialty), and/or Prozac (which may be a treatment, a medication, and/or a pharmaceutical). Next, operation 402 may determine that the user has submitted the request data. In operation 404, a medical service (e.g., the medical service 115) related to the request data may be automatically selected using a database. In one or more embodiments, the automatic selection occurs by referencing the database having a comprehensive set of entries covering instances of the request data that may be submitted. The entries may allow an association between the content of the request data 104 and a diagnosis, which may in turn allow for an automatic association between the diagnosis and the medical service 115 by referencing the medical services data 106. For example the symptom “depression” may be associated with a diagnosis of “depression.” Similarly, symptom of “lethargy” may be associated with a diagnosis of “depression.” However, a symptom may also have multiple associations within the database. “Lethargy” may therefore also be associated with “parasitosis.” In one embodiment, the server 100 may employ a logic to determine, given a diverse set of the content of the request data 104, which diagnosis may be implicated and therefore which medical service 115 would be appropriate for the user to submit to the online medical marketplace 110 For example, where the symptoms input by the user was both “lethargy” and “sadness,” a stronger association to a diagnosis of depression may result than to a diagnosis of “parasitosis.” Therefore, the medical services 115 may include a consultation by a psychologist, rather than a consultation by a physiatrist. In the context of the alternative approaches 302, an herbal remedy of Saint John's Wart, which may include the natural chemical compound hypericin to treat depression, may be offered as one of the medical services 115 rather than an anti-parasite herbal regimen such as cinnamon, ginger, and cardamom. When the content of the request data 104 may be inconsistent, such as when the request data 104 includes a symptom of “depression” and “fever,” additional questions may be asked of the user or only a portion of the content of the request data 104 used to determine the appropriate instances of the medical service 115 and/or the set of the components 111 for each instance of medical service 115.

Operation 406 may automatically select a set of components (e.g., the set of components 111) required to fulfill the medical service using a database. The component 111 may be general, such as “a surgery,” a “consultation,” or a “facility.” The component 111 may also be specific, such as “appendectomy,” and “intravenous vitamin B12 therapy.” In addition, several alternative instances of the components 111 may be associated with each medical service 115. For example, the component 111 representing general anesthesia may be available for a wide range of surgeries and/or other treatments and procedures. In addition, the component 111 representing anesthesia may be available as an optional component for some instances of the medical service 115, e.g., a root canal or magnetic resonance imaging (MRI). While the application of general anesthesia may represent a different transactional cost for the provider 112 bidding on the component 111 representing the anesthesia, the transactional cost may be able to be identified by the grouping of the component 111 to other components 111 of the medical service 115, such as when anesthesia is required for the component 111 of open heart surgery.

A number of operations may then help to distribute and/or list the online medical marketplace 110 the set of components 111 to be bid upon by the providers 112. Operation 406 may apply a geographic constraint of the medical service when the user selects a geographic preference. The user may decide that he or she would like the provider 112 to be in a specific region or within close proximity. The user may also decide that they would like to solicit bids from a set of the providers 112 in a geographic area known for low cost healthcare associated with medical tourism, for example Thailand. Similarly, operation 410 may apply a time constraint of the medical service when the user selects a time preference. The user may require that the medical service 115 and/or an individual instance of the component 111 comprising the medical service 115 take place within a certain time period or have some other temporal constraint. Operation 412 may list each of the set of components required to fulfill the medical service in an online medical marketplace (e.g., the online medical marketplace 110). The online medical marketplace 110 may be an e-commerce website hosted on the server 100 or a different sever connected to the network 101. The online medical marketplace 110 may have a browser-based graphical user interface (GUI) that may allow the set of providers 112 to view and submit bids on the components 111 that the user may submit.

Operation 414 may determine that each of the set of components has received a bid from a provider that is compatible with each one of the other providers submitting bids related to at least one of the set of components based on an availability of each of the providers submitting bids related to at least one of the set of components. The response data 116 may be transmitted to the user once a bid from each of the providers 112 has been associated with each of the components 111. However, the server 100, through operation 414, may determine that only a set of the bids by the providers 112 are compatible with each other based upon an availability of one or more of the providers 112. For example, a first provider may specify, when bidding on one or more of the components 111, that the first provider is only available for scheduling after six weeks, or may even list specific time ranges within a workflow allowing the provider to bid on one or more of the components 111. A second provider may specify that the provider is only available within the next two weeks. Therefore, the first provider and the second provider may be incompatible. In one embodiment, multiple instances of the response data 116 may be generated and presented to the user to account for different combinations of compatibility based upon the set of bids from the set of providers 112. In another embodiment, the “availability” of the set of providers 112 may be based upon whether the set of providers are “in-network” (e.g., within the parameters of an insurance company policy) for the user. The user may specify the user's insurance type and/or insurance network as part of a listing in the online medical marketplace 110.

Operation 416 may communicate a response data (e.g., the response data 116) to the user, the response data comprising associated bids from each of the providers submitting bids related to at least one of the set of components. The response data 116 may comprise a set of bids by each of the providers 112 corresponding to each of the set of components 111. The bids on each component may include a cost in dollars or another currency. The response data 116 may be displayed on a graphical user interface of a device of the user, and the response data 116 may further include an information relating to which insurance companies, insurance programs and/or insurance networks the provider 112 may be a part of. The provider 112 may also be able to specify additional terms and conditions associated with the bid that may be included within the response data 116.

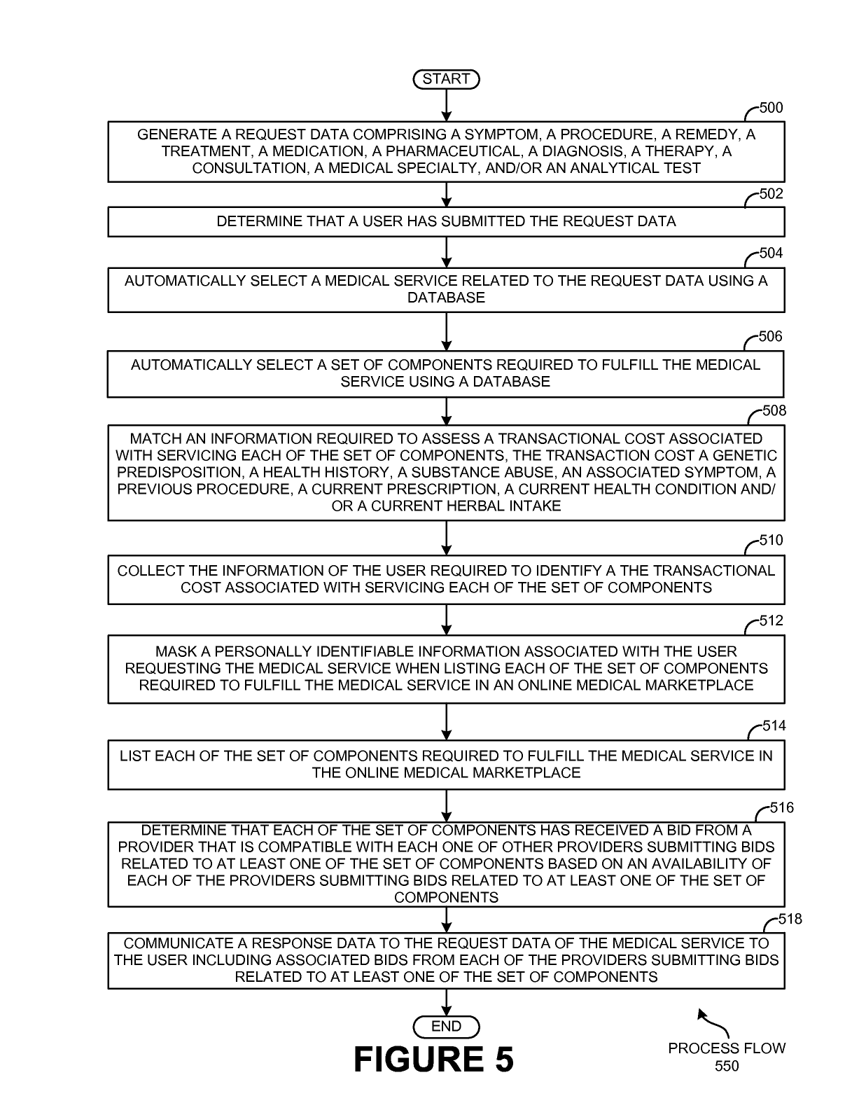

FIG. 5 is a process flow showing the method by which the set of components required to fulfill the medical service of FIG. 4 may require an information to allow a provider to assess a transactional cost associated with servicing each of the set of components, the information collected and a personally identifiable information associated with the user masked when listing each of the components in the online marketplace, according to one or more embodiments. Operation 500 may generate a request data comprising a symptom, a procedure, a remedy, a treatment, a medication, a pharmaceutical, a diagnosis, a therapy, a consultation, a medical specialty, and/or an analytical test. Operation 502 may determine that a user has submitted the request data. Operation 504 may automatically select a set of components required to fulfill the medical service using a database.

Operation 506 may match an information required to identify a transactional cost associated with servicing each of the set of components, the transaction cost a genetic predisposition, a health history, a substance abuse, an associated symptom, a previous procedure, a current prescription, a current health condition and/or a current herbal intake. Specifically, a specific component 111 may implicate the information required to identify the transactional cost associated with servicing the specific component 111. For example, where the component 111 is “open heart surgery,” a weight of the user may (when the user is the potential patient) may be important for a surgeon to determine a risk associated with performing the surgery. In some cases, as which may be the case with a teeth cleaning procedure, no additional information may be required in order for one or more of the set of providers to identify the transactional costs associated with servicing the component.

Operation 510 may collect the information of the user required to identify the transactional cost associated with servicing each of the set of components. The information of the user may be collected by sending a request to the user for the information. For example, the user may be asked to describe a procedure the user previously underwent or to describe a family genetic history. However, in one or more embodiments, the information required to identify the transactional cost associated with servicing the component 111 may be imported through an API, for example from the medical institution 144, as shown and described in conjunction with FIG. 1.

Operation 512 may mask a personally identifiable information associated with the user requesting the medical service when listing each of the set of components required to fulfill the medical service in an online medical marketplace. Masking and/or the making anonymous of the personal information may be required to comply with government regulations (e.g., the Health Information Privacy Protection Act) and may be additionally required for the user to feel comfortable submitting information (e.g., a symptom of the request data 104 that may be embarrassing) to the server 100. Therefore, in relation to operation 510 and 512, a non-personally identifiable information may be collected from the user and disclosed in the online medical marketplace (e.g., the weight of the user, a general family history such as “my aunt and grandmother diagnosed with breast cancer”) without disclosing the identity of the user.

Operation 514 may list each of the set of components required to fulfill the medical service in the online medical marketplace. Operation 516 may determine that each of the set of components has received a bid from a provider that is compatible with each one of other providers submitting bids related to at least one of the set of components based on an availability of each of the providers submitting bids related to at least one of the set of components. Operation 518 may communicate a response data to the user, the response data comprising associated bids from each of the providers submitting bids related to at least one of the set of components.

FIG. 6 is a compatible provider reverse bidding view showing a consumer (who may be the user) formulating a medical service comprising a set of components and submitting the medical service to the online medical marketplace of FIG. 1 to be bid upon by the set of providers to result in a response data of a set of providers compatible to service the set of components in order to complete the medical service, according to one or more embodiments. Specifically, FIG. 6 further illustrates a set of components 111A through 111C, an additional component 111D, and a set of bids 611A through 611N.

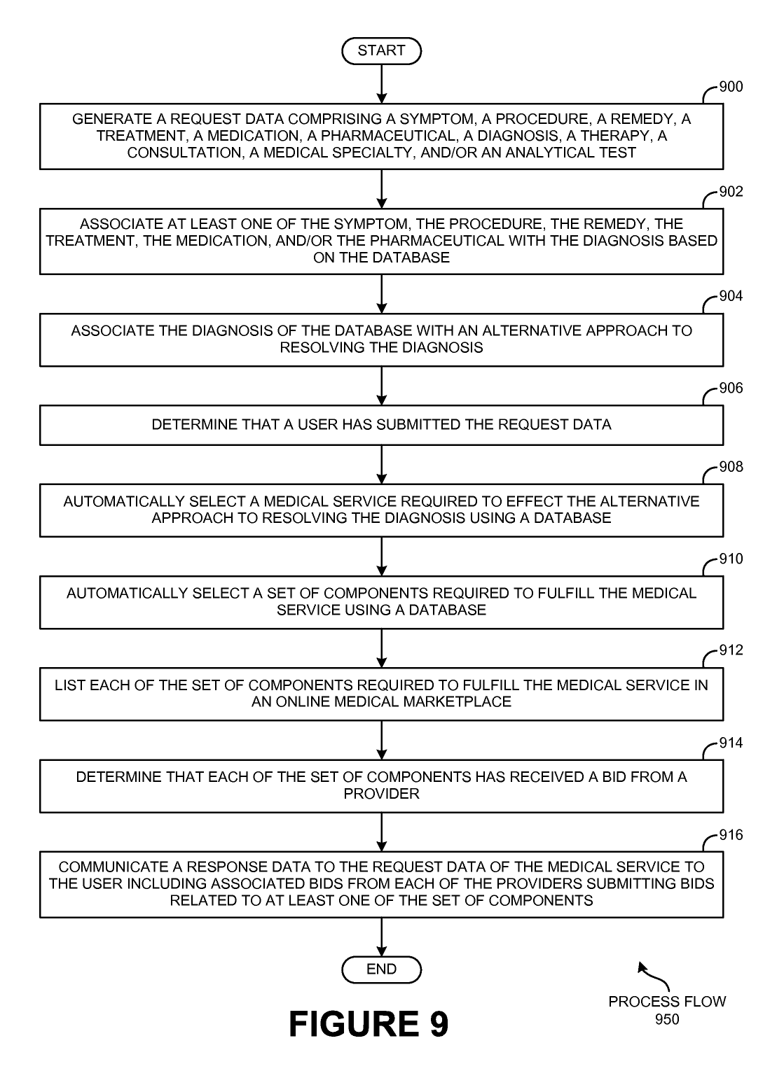

The consumer 102 may submit the set of components 111A through 111C to the online medical marketplace 110 along path ‘circle 1’, the set of components 111A through 111C having been determined and formulated according to, in one or more embodiments, the operations shown and described in the process of FIG. 4, FIG. 5 and/or FIG. 9. The consumer 102 may also specify and/or designate a “preferred provider” that the consumer 102 may have had a previous positive experience with and/or appreciate for some other additional reason such as a positive review by a different user of the online medical marketplace 110.

The set of providers 112 may then bid on the set of components 111 listed in the online medical marketplace 110. The provider administrator 113, who may represent the provider group 114 and/or the set of providers within the provider group 114 (e.g., the provider 112A and the provider 112B), may browse or subscribe to listings in the online medical marketplace based on a set of criteria such as the type of components 111 listed and/or metadata associated with each of the component 111. The metadata may be, for example, a medical specialty associated with the component such that the provider 112 may sort the set of listings in the online medical marketplace 110 by the medical specialty. The provider administrator 113 may have a permission from the provider 112A to bid on behalf of the provider 112A, as seen along paths represented by path ‘circle 2.’ In this way, provider 112A may indirectly place the bid 611A on the component 111A of the consumer 102. Provider 112B, also a member of the provider group 114, may place the bid 611C on component 111C. Knowing that the component 111B cannot be provided by the provider group 114, the provider 112B may then forward a link to the online medical marketplace 110 to the provider 112C to recommend that the provider 112C place the bid 611B on the component 111B as shown in path ‘circle 4.’ Provider 112C may then place the bid on component 111B as shown in path ‘circle 5.’ Provider 112D may then place a bid on component 111C along path ‘circle 6.’ Provider 112N may believe that a component of the medical service 115 may be missing, and may therefore add an optional instance of the additional component 111D along path ‘circle 7’ and may then place the bid 611D on the additional component 111D along path ‘circle 8.’ Along path ‘circle 9’ the response data may be generated by the server 100 determines that each of the components 111A through 111D have an associated bid by at least one of the set of providers 112A through 112N, e.g., the set of bids 611A through 611N. The bid placed by provider 112D may be determined to be incompatible with one or more of the other providers 112 placing bids, and therefore may not end up comprising the response data 116. The response data 116 may then be submitted to the consumer 102 and consumer 102 may then decide to accept or reject the bids 611A through 611D, individually or collectively.

FIG. 7 is an individual component bidding view that shows one or more associated bids on each of the set of components, the response data presenting each bid of each provider on each component such that the consumer may choose the best bid for each component, according to one or more embodiments. Particularly, FIG. 7 further illustrates the elements of two provider groups, provider group 114K having a provider administrator 113X and provider group 114L having the provider administrator 113Y, and also illustrates a linked bid 700 and an additional service 711.

In FIG. 7, the consumer 102 may submit the components 111A through 111C to the online medical marketplace 110. The set of providers 112A though 112N may bid on one or more of the set of the components 111 along paths ‘circle 2’ through ‘circle 7’ to yield the set of bids 611A through 611F. In addition, the provider 112N may append to a description of component 111C an extra procedure that may distinguish the provider 112N over the set of other providers 112N. For example, where the component 111C represents an MRI diagnostic procedure, the provider 112N may specify that they will conduct an open-air MRI rather than a traditional MRI in which the consumer 102 may feel claustrophobic. In the context of the alternative approaches 302, the additional service 711 may be an added foot massage where the component 111C was a facial massage. In this way, the set of providers may be able to distinguish their products and/or services required to service one or more of the components 111A through 111C using a different mechanism than a bidding price.

In the embodiment of FIG. 7, the consumer 102 may be presented with each and every bid placed by one of the set of providers 112A through 112N without regard to compatibility. The consumer 102 may then decide which of the set of components 111 to purchase from which of the providers 112. However, the provider 112 may, in one or more embodiments, be able to condition acceptance of a bid on one of the components 111 (e.g., the component 111A) with the acceptance of a bid on another one of the components 111 (e.g., the component 111B). In FIG. 7, for example, the provider group 114L that may submit the bid 611B on the component 111A and may condition acceptance of the bid 611B on the acceptance by the consumer 102 of the bid 611C by the provider 112C who may be included within the provider group 114L.

FIG. 8 is an organizational leveraged bargaining view showing an organization administrator of an organization submitting a medical service comprising a block of multiple units of a first component and a second component to be bid upon by the set of providers, the organization administrator selecting the appropriate bids within the response data to form an electronic contract obligating the set of providers selected by the organization administrator to provide a medical service associated with the first component and the second component to an employee (e.g., a full-time employee, a part-time employee, a contractor) of the organization, according to one or more embodiments. Specifically, FIG. 8 further illustrates an electronic contract 800 and a component block 811A and 811B of repeated instances of a component 111A and 111B, respectively.

In FIG. 8, the organization 118 may wish to use a bargaining power to receive a relatively low price on bulk medical service contracts that they may offer to their employees (e.g., the part-time employee 120B) and contractors (e.g., the contractor 120C). In other words, the organization 118 may have an ability to offer the medical service 115 as a form of incentive or benefit that is in addition to and/or supplants traditional medical insurance benefits. This may be important in the context of the part-time employee 120B, who may not be eligible for a medical insurance covering of the organization 118 for which the full-time employee 120A may be eligible. In this way, the organization 118 may still offer some form of benefit, at nominal additional cost to the organization 118 (e.g., a subscription fee for placing listings in the online medical marketplace 110). The organization 118 may also then have a system to prevent loss of productivity of the part-time employee 120B and the contractor 120C due to delayed or avoided contact with the medical services industry (e.g., a sickness getting worse because the contractor 120C wishes to avoid the expense of seeing a doctor).

In FIG. 8, the organization 118 through the organization administrator 119 may submit to the online medical marketplace the block of components 811A comprising one hundred units of the component 111A and the block of components 811B comprising 50 units of the component 111B along path ‘circle 1’. In one or more embodiments, the organization 118 may have a different workflow and/or a different mode of submitting the request data 104. For example, the organization administrator 119 may be considered of a higher sophistication than the consumer 102. Therefore, the organization administrator 119 may use a different graphical user interface that may allow for manual selection of the components 111A and 111B, along with how many units of each may be required by the organization 118. For example, the organization 118 may be a manufacturing company that encounters an occupational hazard such as carpel tunnel syndrome. Therefore, the organization 118 may wish to have one or more providers 112 bid on both consultation to identify an early onset of carpel tunnel syndrome and 50 carpel tunnel syndrome treatments (e.g., surgeries). In addition to manual selection of the medical service 115 and/or the components 111, the organization administrator 119 may cause the request data 104 comprising a symptom, a procedure, a remedy, a treatment, a medication, a pharmaceutical, a diagnosis, a therapy, a consultation, a medical specialty, and/or an analytical test to be generated. For example, the organization administrator 119 may submit a symptom which is common within the organization 118 such as a flu, or may submit an analytical test that may be used to screen for an occupational hazard (e.g., exposure to benzene). The request data 104 may be analyzed by the server 100, the horizontal array engine 140, and the vertical array engine 142 in order to present the organization administrator 119 with the alternative approaches 302.

Along paths ‘circle 2’ to ‘circle 4,’ the set of the providers 112A through 112N may place bids on the component block 811A (which may have associated bids 611A and 611B) and on the component block 811B (which may have associated bids 611C, 611D, and 611E). In one or more embodiments, the block component 811 may be divisibly bid upon by the set of providers 112. For example, the provider 112N may choose to only bid upon ten of the fifty units of the components 111B associated with the block component 811B due to a lack of capacity to service a higher number of units. Along path ‘circle 5,’ the response data 116 may be generated and transmitted along path ‘circle 6’ to the organization administrator 119. The organization administrator 119 may then accept or reject the bids 611A through 611E and transmit the acceptance and/or rejection to the server 100. In the embodiment of FIG. 8, the organization administrator 119, along path ‘circle 7’ may accept half of the block component 811A (50 units) from the provider group 114K and half of the block component 811A (50 units) from the provider 114D. The organization administrator 119, along path ‘circle 7’ may also accept the bid 611E on the block component 811B from the provider 112D.

The result of the acceptance of the bids on the block components 811A and 811B may be the generation, along path ‘circle 8’, of the electronic contract 800 which may bind: the provider group 114K to service 50 units of the component 111A to individuals of the organization 118 (e.g., the full-time employee 120A, the part-time employee 120B, and/or the contractor 120C) at the price of the bid 611A; the provider 114K to service 50 units of the component 111B to individuals of the organization 118; and the provider 112D 50 units of the component 111B to individuals of the organization 118. Along path ‘circle 9,’ each of the components 111A and 111B may be offered to the individuals of the organization 118 (e.g., the full-time employee 120A, the part-time employee 120B, and/or the contractor 120C) at the choice of the organization administrator 119. In one or more embodiments, the electronic contract 800 may function as a limited-scope services contract with the organization 118 to provide medical services (e.g., the medical service 115 and/or the components 111A and 111B) to individuals of the organization 118.

In an alternative embodiment, and as shown in conjunction with the embodiment of FIG. 1, the organization 118 may be an insurance company that ordinarily provides medical insurance to a set of consumers (e.g., the insurance company 122). In such case, the insurance company 122, through the insurance administrator 123, may bargain on behalf of a set of the policy holders 124.

FIG. 9 is a process flow showing the method by which the request data may be associated with a diagnosis which may in turn be associated, using a database, with an alternative approach to resolving the diagnosis and automatically selecting a medical service required to effect the alternative approach along with the set of medical components required to fulfill the medical service, according to one or more embodiments. Operation 900 may generate a request data comprising a symptom, a procedure, a remedy, a treatment, a medication, a pharmaceutical, a diagnosis, a therapy, a consultation, a medical specialty, and/or an analytical test. Operation 902 may associate the symptom, the procedure, the remedy, the treatment, the medication, and/or the pharmaceutical with the diagnosis based on the database. Operation 904 may associate the diagnosis of the database with an alternative approach to resolving the diagnosis. In one or more embodiments, operation 904 may employ the horizontal array engine 140. Operation 906 may determine that a user has submitted the request data. Operation 908 may automatically select a medical service required to effect the alternative approach to resolving the diagnosis using a database. In one or more embodiments, operation 908 may employ the vertical array engine 142.

Operation 910 may automatically select a set of components required to fulfill the medical service using a database. Operation 912 may list each of the set of components required to fulfill the medical service in an online medical marketplace. Operation 914 may determine that each of the set of components has received a bid from a provider. Operation 916 may communicate a response data to the user the response data comprising associated bids from each of the providers submitting bids related to at least one of the set of components.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., the server 100). Accordingly, the specification and drawings are to be regarded in an illustrative rather than a restrictive sense.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

What is claimed is:

1. A computer system comprising:
a central server including:
a non-transitory computer readable memory including a database, wherein the database associates medical services with treatment components;
a processor;
wherein the central server is in communication with:
an insurance server including an insurance database;
a consumer device, wherein the consumer device sends request data specifying a medical service;
wherein the processor is configured to:
receive the specified medical service;
access the database to determine the treatment components capable of fulfilling a portion of the specified medical service;
group the treatment components into sets of treatment components, wherein the set of treatment components is capable of fulfilling the specified medical service;
for each of the sets of components, determining different options for each of the components;
for each of the sets of components, presenting a particular set of components including a suggested set of components, wherein the suggested set of components includes one option for each of the components in the particular set of components;
wherein the central server receives a selected set of components from the consumer device.

2. The computer system of claim 1, wherein the specified medical service comprises a symptom, a remedy, a pharmaceutical, a diagnosis, a therapy, a consultation, a medical specialty, or an analytical test.

3. The computer system of claim 1, wherein the database includes treatment components associated with western medicine, eastern medicine, and Ayurvedic medicine.

4. The computer system of claim 1, wherein the server is further in communication with a provider network that communicates a cost to perform each component of the sets of components by at least one provider.

5. The computer system of claim 4, wherein the provider network communicates a timeframe for the communicated cost for each provider.

6. The computer system of claim 5, wherein each of the components included in the suggested set of components have a required order and the timeframe for each of the components included in the suggested set of components have nonconflicting timeframes.

7. The computer system of claim 1, wherein the processor is further configured to associate at least one of a symptom, a procedure, a remedy, a treatment, a medication, and a pharmaceutical with a diagnosis based on the database; and
associating the diagnosis of the database with an alternative approach to resolving the diagnosis.

8. A graphical user interface communicated to a user for providing treatment options to treat a specified condition, the graphical user interface including:
an upper portion including a segmented row of alternative approaches, wherein each of the alternative approaches are associated with and labeled with a particular treatment discipline;
a treatment column under each of the alternative approaches in the segmented row, wherein each of the treatment columns include:
an ordered list of treatment components, wherein:
completion of the entirety of each ordered list of treatment component represents a possible treatment option for the specified condition;
each treatment component in the list of treatment components is ordered such that a particular treatment component that requires previous completion of another treatment component is listed after the another treatment component.

9. The graphical user interface of claim 8, additionally including response data comprising associated bids related to at least one of the set of components that are required to fulfill one of the listed medical services, wherein each of the associated bids have been verified to comply with at least one of a time constraint based on a location of the treatment component associated with the bid within the ordered list of treatment components.

10. The graphical user interface of claim 8, wherein the particular treatment disciplines include western non-traditional medicine, conventional medicine, nutritional/lifestyle, eastern medicine, ayurvedic medicine, experimental medicine, and spiritual healing.

11. The graphical user interface of claim 8, wherein each of the set of components required to fulfill the medical service is at least one of a facility, any one of the procedure and a different procedure, any one of the remedy and a different remedy, any one of the treatment and a different treatment, any one of the medication and a different medication, any one of the pharmaceutical and a different pharmaceutical, any one of the therapy and a different therapy, the consultation, an ambulation service, and any one of the analytical test and a different analytical test.
